(19) United States
(12) Patent Application Publication
(10) Pub. No.: US 2011/0154883 A1
(43) Pub. Date: Jun. 30, 2011

(54) ANALYZER FOR ANALYZING THE ACETALDEHYDE CONTENT OF PREFORMS

(76) Inventors: Carlo Squicciarini, Carate Brianza (IT); Sergio Sonzogni, Grassobbio (IT)

(21) Appl. No.: 12/997,680

(22) PCT Filed: Jun. 12, 2008
(86) PCT No.: PCT/IB08/01505

§ 371 Date: Mar. 11, 2011

(51) Int. Cl. G01N 30/88

(52) U.S. Cl. 73/23.35

(57) ABSTRACT

A system for analyzing the content of a gas, characterised by comprising means for drawing off the gas developed during article moulding; means for feeding the drawn-off gas to a gas chromatograph.

The present invention relates to an analyzer for analyzing the acetaldehyde content of polyethylene terephthalate products, particularly preforms. More generally it relates to a system and method for analyzing the content of a gas developed by performs.

The determination of the acetaldehyde (AA) content of polyethyleneterephthalate (PET) preforms, as an index of degradation, is a known current test used to verify good product quality. The analytical approach comprises sample preparation by cryogenic grinding of the preform and gas chromatographic analysis by the headspace technique.

To obtain significant data, the acetaldehyde standard must be distilled, the distillate must be titrated and a series of standards be prepared for use in constructing an external calibration network. The difficulty in standardizing the above operations is considerable.

In this respect, data characterised by good repeatability (within the laboratory) are very often not reproducible between one laboratory and another, even when using the same procedure. The sample preparation factor plays a determining role.

Moreover, apart from the cost of effecting such an analysis, the technical times involved in carrying out the test are such as to enable only a sporadic process check, considering the number of preforms produced in a normal production plant.

WO03083468 describes a method for analyzing the acetaldehyde content of preforms by placing the sample in a desorption cell, purifying the cell with air, heating the sample and transferring the emitted gas to a gas chromatograph for analysis. With this method the time for implementing the examination is reduced compared with the previous time.

An object of the invention is to provide a method for analyzing the acetaldehyde content of preforms which is even faster than previous methods.

Another object is to provide a method which enables the acetaldehyde quantity to be monitored and controlled during preform moulding. These and other objects are attained according to the present invention by a system for analyzing the content of a gas characterised by comprising means for drawing off the gas developed during article moulding; means for feeding the drawn-off gas to a gas chromatograph.

Further characteristics of the invention are described in the dependent claims.

The fact of having realized that the gas to be measured is developed during preform moulding, and that this gas is proportional to that contained in the preform itself, has enabled the previously required analysis time to be considerably reduced.

Moreover, the production process does not have to be interrupted.

The solution proposed herein can also be applied to existing machines by making simple modifications.

The characteristics and advantages of the present invention will be apparent from the ensuing detailed description of a practical embodiment thereof, illustrated by way of non-limiting example in the accompanying drawings, in which:

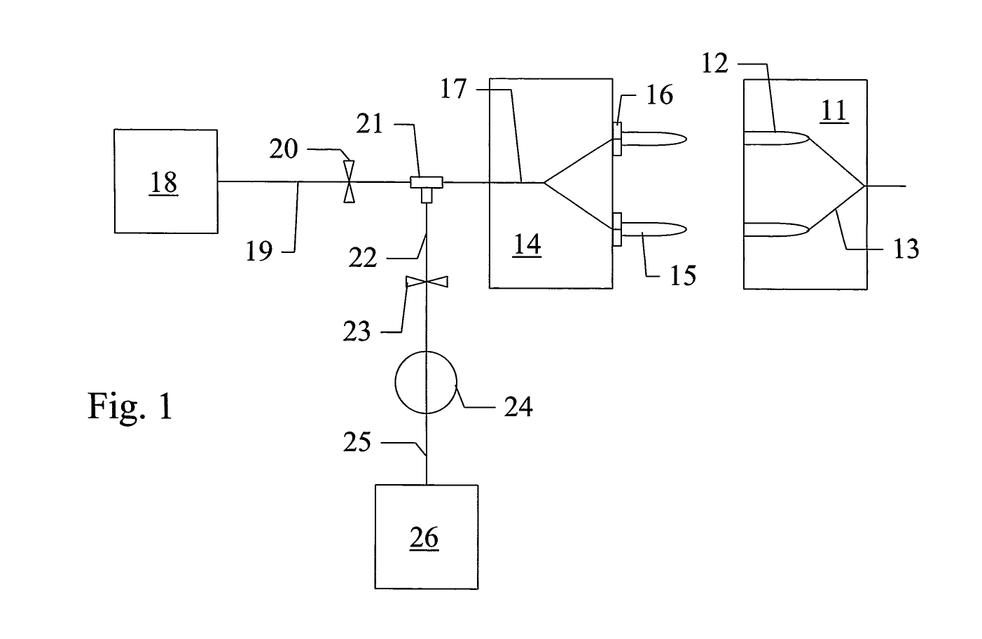

FIG. 1 shows schematically an analyzer for analyzing the acetaldehyde content of preforms, in accordance with the present invention.

A reciprocatingly operating machine for producing preforms by injection moulding normally comprises a screw extruder for melting and advancing the polymer resin. It comprises an injection chamber provided with an injection piston having an injection nozzle connected to the hot channel network of the hot part of the mould. It comprises the injection cavities, the mould plugs, the plug carriers and the cheeks of the cold part of the mould. It also comprises a series of tubes each connected to the rear surface of the plug carriers and conveying the service air at 10 bar for aiding preform extraction by means of an air jet just after the two halves of each jaw have been opened, to facilitate preform insertion into the hand of a robot used for preform extraction.

In this respect, each of the plug carriers is provided with two air passage holes which reach their front surface.

The described tubes converge into a single main pipe fed by a compressed air receiver. A solenoid valve connects the receiver to the phps.

With reference to the accompanying FIGURE, a preform production machine comprises a mould hot part in which cavities 12 are provided. The mould hot channels 13, through which the prp arrives, reach the cavities 12.

It also comprises a mould cold part 14 in which the mould plugs 15 and the relative cheeks 16 are provided.

The compressed air tubes 17 converge at the plugs, in particular at the to holes positioned on the rear of the plug carriers.

The compressed air originates from a receiver 18 via a connection pipe 19.

According to the present invention, a solenoid valve 20 and a T-connector 21 are connected in series between the connection pipe 19 and the compressed air tubes 17, starting from the receiver 18.

A pipe 22 connected to the third outlet of the T-connector 21 is connected to a solenoid valve 23, and then to a suction system 24. The suction system 24 must be sufficiently powerful to rapidly draw off a large quantity of gas.

The outlet of the suction system 24 is connected via a pipe 25 to a gas chromatograph 26.

For the system to be of maximum efficiency, the following described events must occur in sequence.

Analysis initiation request.

Awaiting initial useful mould closure after analysis request and commencement of molten polymer injection into the cavities.

The closure signal for the mould 11, 14 closes the solenoid valve 20 upstream of the T-connector, opens the solenoid valve 23 and at the same time triggers the suction system 24.

Gas draw-off commences, then during the final time fraction for which draw-off is in operation, typically during the last second; the gases are conveyed to a gas sampling valve, which then directs them to the gas chromatography column.

Draw-off remains in operation as long as possible, and in any event until the signal for commencement of preform extraction by opening the two halves of the cheeks 16.

The suction system is then deactivated, the solenoid valve 23 is closed and the solenoid valve 20 opened.

The robot takes the preforms from the mould, then the machine and the gas chromatography system continue their own operating cycles independently.

The machine cycle continues with blowing compressed air through the pipes serving the plugs, to hence contribute to completely cleaning said pipes from the acetaldehyde previously drawn in during the analysis cycle.

The mould is again closed and the machine cycles follow one after another without undergoing any alteration or slowdown.

The analytical system then becomes available for a new analysis after the entire acetaldehyde quantity has been removed from the column and has reached the detector (3-5 minutes).

The present analyzer enables the concentration of volatile substances and in particular acetaldehyde to be measured in the gases extracted from the injection mould after moulding plastic articles in general and polyethylene terephthalate articles in particular.

This concentration is directly related to the acetaldehyde content of the preforms, when measured by the widely known reference method used in this sector (headspace gas chromatography after cryogenically grinding the preform). From tests carried out, it has been found that the square of the correlation coefficient R² is equal to 0.9707 between the value of the peak area in the gas drawn in and the peak area in the headspace on the ground preform.

The measurement of the present invention has the advantage of being carried out in-line during normal machine operation, which therefore needs no alteration in any manner and takes typically from 3 to 5 minutes from the analysis request, to provide the final information. This information can be automatically fed to the computer controlling the injection machine, to form in effect a monitored process variable, possibly in closed cycle, to allow feedback on those variables which most directly influence the acetaldehyde level in the preform (temperatures, injection pressures, etc.), to hence ensure an acetaldehyde value which is much more constant with time.

In addition, extracting the gaseous fractions from the injection cavities during their filling with the molten polymer (in relation to the analytical measurement), possibly done automatically without making the measurement, is able to reduce, even if only slightly, the final preform acetaldehyde content typically by 5-10% compared with a traditional process without gas extraction. This technique not only does not alter the machine operating cycle, but contributes to limiting the preform acetaldehyde concentration.

There are also other facilities for drawing off the gases developed by the included preforms, such as:

That of using the air draw-off circuit on the rear of the robot's hand, normally used to put the robot cavities under negative pressure and facilitate preform entry into said cavities.

That of withdrawing the gases on the hot part of the mould via appropriate access points to be provided at the mould design stage able to communicate with the injection cavities.

That of withdrawing the gases upstream of the mould at a point of the extrusion die to which access is possible by a draw-in conduit (there exist for example so-called vacuum extruders, at a particular point of which there is an aperture towards the outside which enables the vapours produced during extrusion to be drawn off; it would be possible for example to position at this point a draw-off system for collecting the acetaldehyde or volatile substance vapours and analyze them).

The system so conceived is susceptible to numerous modifications and variants, all falling within the scope of the inventive concept; moreover all details can be replaced by technically equivalent elements.

1. A system for analyzing the acetaldehyde content of polyethyleneterephthalate preforms, characterised by comprising:
means for drawing off the gas developed during performs moulding;
means for feeding the drawn-off gas to a gas chromatograph, wherein the gas is withdrawn from the cold part of a mould in which mould plugs and relative cheeks are provided.

2. (canceled)

3. A system as claimed in claim 1, characterised in that said means for drawing off the gas developed during moulding comprise a suction system for drawing off said gas from a compressed air circuit used to extract the preforms from the mould.

4. A system as claimed in claim 1, characterised in that said means for drawing off the gas developed during moulding comprise a suction system for drawing off said gas from a suction circuit present on a robot for removing said preforms from the mould.

5. A system as claimed in claim 1, characterised in that said means for drawing off the gas developed during moulding comprise a suction system for drawing off said gas from a circuit for feeding the moulding material to the mould.

6. A system as claimed in claim 1, characterised in that said means for drawing off the gas developed during moulding comprise means for blocking the compressed air flow during the draw-off period of said gas.

7. A system as claimed in claim 1, characterised in that said means for drawing off the gas developed during article moulding comprise means for blocking the suction flow during the normal production cycle.

8. A method for analyzing the content of the acetaldehyde content of polyethyleneterephthalate preforms, comprising the steps of drawing off the gas developed during performs moulding; feeding the drawn-off gas to a gas chromatograph, wherein the gas is withdrawn from the cold part of a mould in which mould plugs and relative cheeks are provided.

9. A system as claimed in claim 1, characterised in that said mould plug comprise plug carriers, and the gas is withdrawn from holes positioned on the rear of said plug carriers.

10. A method as claimed in claim 8, further comprising the steps of awaiting initial useful mould closure after analysis request and commencement of molten polymer injection into the cavities before the step of drawing off the gas.

11. A method as claimed in claim 10, further comprising the steps of taking the preforms from the mould, then blowing compressed air through pipes serving the plugs, to hence contribute to completely cleaning said pipes from the acetaldehyde previously drawn in during the analysis cycle.
